(19) United States
(12) Patent Application Publication
(10) Pub. No.: US 2008/0305295 A1
(43) Pub. Date: Dec. 11, 2008

(54) MOSAIC

(76) Inventor: Brian H. Welker, Sugar Land, TX (US)

Correspondence Address: HUSCH BLACKWELL SANDERS LLP, 4801 Main Street, Suite 1000, KANSAS CITY, MO, 64112, US

(21) Appl. No.: 11/947,450

(22) Filed: Nov. 29, 2007

Related U.S. Application Data
(62) Division of application No. 11/613,885, filed on Dec. 20, 2006.

(51) Int. Cl. B44C 1/28

(52) U.S. Cl. 428/67

(57) ABSTRACT

A mosaic formed from bony processes. The mosaic includes a generally planar substratum and at least one bony process that is cut into a plurality of cross-sectional pieces. The bony process cross-sectional pieces can be polished using an abrasive material. The cross-sectional pieces are arranged on and may be affixed to the substratum. The voids created by the arranging of the cross-sectional pieces can be filled with a material.

### CROSS-REFERENCE TO RELATED APPLICATIONS

This application is a Divisional of and claims priority to U.S. application Ser. No. 11/613,885 filed Dec. 20, 2006, currently pending, entitled “Mosaic and Method for Producing It,” the entire disclosure of which is incorporated herein by reference to the extent permitted by applicable law.

### BACKGROUND OF THE INVENTION

Mosaics have existed for centuries. Mosaics are surface decorations made by inlaying pieces of variously colored material to form pictures or patterns. The pieces of material used to form mosaics are usually ceramic, marble, or stone. The pieces of material are normally held in place by mortar, glue, or grouting.

In rural areas and areas where hunting takes place, it is desirable to have décor that incorporates the sport of hunting into its design. Accordingly, a need exists for a way to produce such décor.

### SUMMARY OF THE INVENTION

The present invention is directed to a mosaic that includes a generally planar substratum and at least one bony process that is cut into a plurality of cross-sectional pieces. The bony process cross-sectional pieces can be polished using an abrasive material. The bony process cross-sectional pieces can also be artificially colored. The cross-sectional pieces are arranged on and may be affixed to the substratum. The cross-sectional pieces can be arranged in a manner to form a design. The cross-sectional pieces may be affixed to the substratum with an adhesive. The voids created by the arranging of the cross-sectional pieces can be filled with a material selected from a group consisting of polyurethane, resin-based material, acrylic, earth, sand, and combinations thereof.

### DESCRIPTION OF THE SEVERAL VIEWS OF THE DRAWINGS

FIG. 1 is a plan view of the mosaic in accordance with one embodiment of the present invention;

FIG. 2 is a right perspective view of the mosaic containing four legs in accordance with one embodiment of the present invention;

FIG. 3 is an exploded view of a deer antler in accordance with one embodiment of the present invention;

FIG. 4A is a plan view of a bony process cross-sectional piece in accordance with one embodiment of the present invention;

FIG. 4B is a plan view of a bony process cross-sectional piece in accordance with one embodiment of the present invention; and

FIG. 4C is a plan view of a bony process cross-sectional piece in accordance with one embodiment of the present invention.

### DETAILED DESCRIPTION OF THE INVENTION

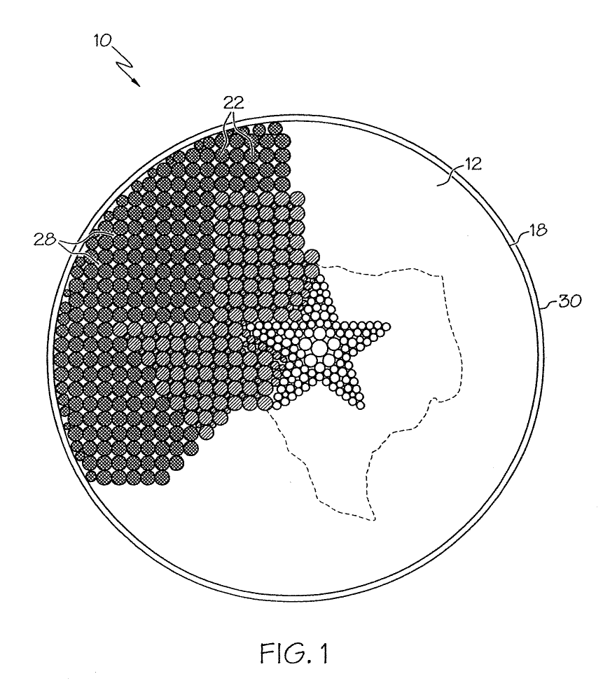

The present invention is directed to a mosaic 10 constructed from bony process cross-sectional pieces 22. As shown in FIG. 1, the mosaic 10 includes a substratum 12 and bony process cross-sectional pieces 22. The substratum 12 has a first side 14, a second side 16, and at least one sidewall 18. The bony process cross-sectional pieces 22 have first sides 24 and second sides 26.

The substratum 12 can be generally planar and be one of many numerous shapes, including, but not limited to, circular, polygonal, trapezoidal, rectangular, square, triangular, and oval. In one embodiment, the substratum 12 has a coefficient of thermal expansion similar to the coefficient of thermal expansion of the bony process or processes 20 used to construct the mosaic 10.

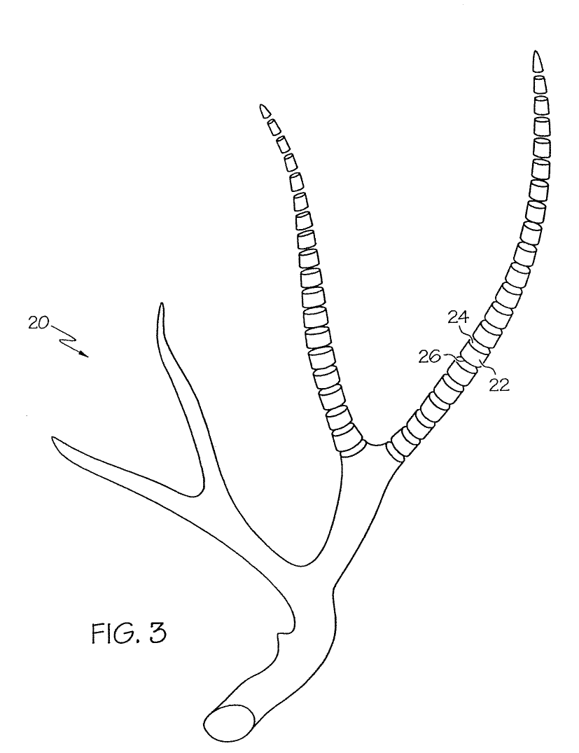

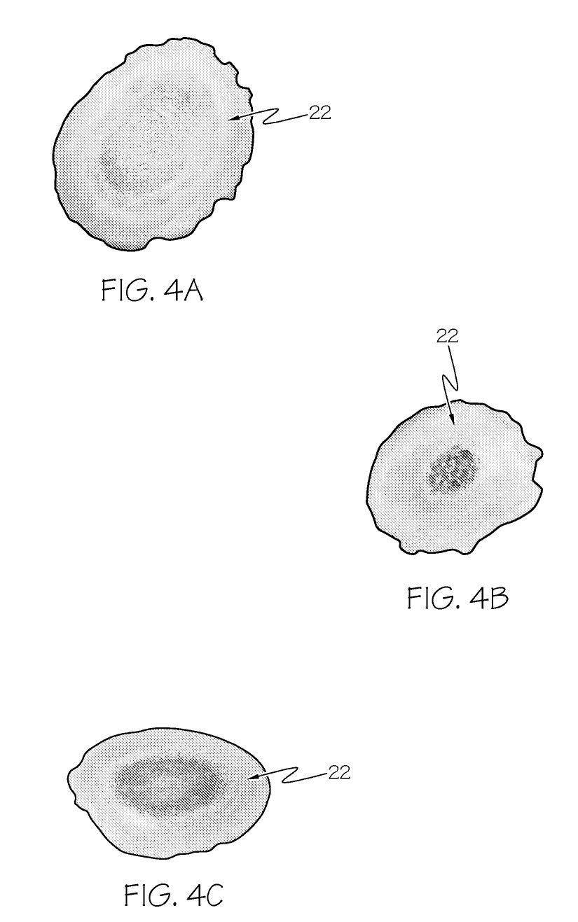

The bony process 20 used to construct the mosaic 10 in the present invention can include an antler, a horn, and combinations thereof. In one embodiment, the bony process 20 used to construct the mosaic 10 is a deer antler, as shown in FIG. 3. Based on numerous factors, deer antler characteristics such as color, porosity, texture, shape, size, and moisture content vary from antler to antler. The variations in characteristics such as color, porosity, texture, shape, and size are illustrated by the differences in the cross-sectional pieces 22 shown in FIGS. 4A, 4B, and 4C.

The characteristics of an antler vary throughout its life cycle. Deer antlers are deciduous, meaning that they are shed at a certain stage of development in their life cycle. Deer generally shed their antlers each spring and immediately begin to grow new ones. During the early stages of an antler's life cycle it is covered with a sensitive skin referred to as “velvet.” The velvet is filled with blood vessels and, thus, the moisture content of the antler is higher when it is covered with velvet in its early stages. Normally, after two to four months, the velvet withers, dries up, and falls off. At this point the moisture content of the antler is lower.

The cross-sectional pieces 22 used in constructing the mosaic 10 can be taken from an antler early in its life cycle, an antler later in its life cycle, or an antler that has been shed by the deer. If desired, the cross-sectional pieces 22 can be freeze-dried to reduce their moisture content.

The bony process 20 may be cut into cross-sectional pieces 22 using a saw, such as a jigsaw or a band saw. The thicknesses of the cross-sectional pieces 22 may vary. In one embodiment of the present invention, the cross-sectional pieces 22 are generally circular and may be from about ⅛ to 1 inch thick, more preferably from ⅛ to ½ inches thick, and most preferably about a ¼ inch thick. In another embodiment, the cross-sectional pieces 22 have substantially identical thicknesses so that they create a substantially flat effect when they are affixed to the substratum 12. In yet another embodiment, the cross-sectional pieces 22 vary in thickness so that they create a three-dimensional effect when affixed to the substratum 12. It will be appreciated by one skilled in the art that the cross-sectional pieces 22 may also be one of many numerous shapes, including, but not limited to, polygonal, trapezoidal, rectangular, square, triangular, and oval.

The cross-sectional pieces 22 may be either polished or left rough. In polishing the cross-sectional pieces 22, the first sides 24 are sanded. The first sides 24 can initially be sanded with sandpaper having an abrasiveness of around 320 grit. Then, the first sides 24 can be sanded with progressively finer sandpapers and can be finished with sandpaper having an abrasiveness of around 1000 grit or crocus cloth. Polishing removes the dust that is deposited in the pores of the first sides 24 during the cutting process. The cross-sectional pieces 22 can be artificially colored, artificially stained, and/or left in their natural state.

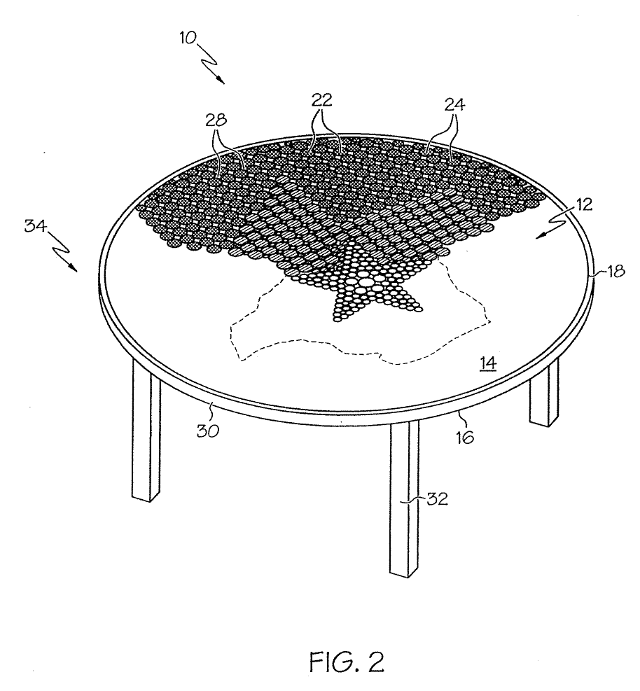

The cross-sectional pieces 22 can be arranged on the substratum 12. The cross-sectional pieces 22 are arranged such that their second sides 26 are placed on the substratum first side 14. In one embodiment, the cross-sectional pieces 22 are arranged in such a manner to form a design. As shown in FIGS. 1 and 2, a design can be formed by strategically arranging cross-sectional pieces 22 with different characteristics such as color, thickness, and size. For example, in one embodiment, as illustrated in FIGS. 1 and 2, the state of Texas with a star in the middle can be formed. Other designs can be formed, including, but not limited to, the logos of sports teams, universities, and corporations.

The cross-sectional pieces 22 can be affixed to the substratum first side 14. In one embodiment, the cross-sectional pieces 22 are affixed to the substratum first side 14 with an adhesive, although it will be appreciated by one skilled in the art that any suitable material may be used to affix the cross-sectional pieces 22 including, but not limited to, adhesive, glue, tape, hooks and loops, tacks, and nails.

The voids 28 in between the cross-sectional pieces 22 may be filled with a material. The material used to fill the voids 28 may be selected from a group consisting of polyurethane, resin-based material, acrylic, earth, sand, and combinations thereof.

The cross-sectional pieces 22 and the material in the voids 28 can be coated with a protective material. In one embodiment, the protective material is a clear polyurethane, although it will be appreciated by one skilled in the art that any suitable protective material may be used to coat the cross-sectional pieces 22 and the material in the voids 28, including, but not limited to, resin varnish, spar varnish, shellac, acrylic, and lacquer.

A border 30 can be affixed to the at least one substratum sidewall 18. The border 30 can serve as a periphery if the mosaic 10 is used as a table top 34 as shown in FIG. 2. The border 30 can also serve as a frame if the mosaic 10 is suspended for display on, for example, a wall.

Additionally, at least three legs 32 may be affixed to the substratum second side 16 to form a table 34 as shown in FIG. 2. In another embodiment, a means for hanging (not shown) may be affixed to the mosaic 10 so that it can be suspended for display.

From the foregoing, it may be seen that the mosaic is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

1. A mosaic comprising:
a generally planar substratum having a first side and a second side; and
at least one bony process cut into a plurality of cross-sectional pieces each of said cross-sectional pieces having a first side and a second side;
wherein said first side of said cross-sectional pieces is polished using an abrasive material;
wherein said cross-sectional pieces are arranged on said substratum first side; and
wherein said second side of said cross-sectional pieces is affixed to said substratum first side.

2. The mosaic of claim 1 wherein said substratum has a coefficient of thermal expansion substantially similar to the coefficient of thermal expansion of said bony process.

3. The mosaic of claim 1 wherein said bony process is selected from a group consisting of horns, antlers, and combinations thereof.

4. The mosaic of claim 1 wherein said bony process has been freeze dried.

5. The mosaic of claim 1 wherein each of said cross-sectional pieces have a thickness of from about ⅛ to 1 inch.

6. The mosaic of claim 1 wherein said cross-sectional pieces have substantially similar thicknesses and are affixed to said substratum first side to create a substantially flat effect.

7. The mosaic of claim 1 wherein said cross-sectional pieces have varying thicknesses and are affixed to said substratum first side to create a three-dimensional effect.

8. The mosaic of claim 1 wherein said first sides of said cross-sectional pieces have been artificially colored.

9. The mosaic of claim 1 wherein said cross-sectional pieces are arranged in a manner to form a design.

10. The mosaic of claim 1 wherein said cross-sectional pieces are affixed to said substratum first side with an adhesive.

11. The mosaic of claim 9 wherein said cross-sectional pieces define voids therebetween.

12. The mosaic of claim 11 wherein said voids are filled with a material.

13. The mosaic of claim 12 wherein said material is selected from a group consisting of polyurethane, resin-based material, acrylic, earth, sand, and combinations thereof.

14. The mosaic of claim 1 wherein said cross-sectional pieces a coated with a protective material.

15. The mosaic of claim 1 wherein said substratum further includes a sidewall and a border is affixed around said sidewall.

16. The mosaic of claim 1 wherein at least 3 legs are affixed to said substratum second side.

17. The mosaic of claim 1 wherein a means for hanging is affixed to said mosaic.

18. A mosaic comprising:
a generally planar substratum having a first side and a second side; and
at least one bony process cut into a plurality of cross-sectional pieces each of said cross-sectional pieces having a first side and a second side;
wherein said first side of said cross-sectional pieces is polished using an abrasive material;
wherein said first side of said cross-sectional pieces is artificially colored;
wherein said cross-sectional pieces are arranged on said substratum first side in a manner to form a design;
wherein said second side of said cross-sectional pieces is affixed to said substratum first side with an adhesive; and
wherein voids created by arranging of said cross-sectional pieces are filled with a material selected from a group consisting of polyurethane, resin-based material, acrylic, earth, sand, and combinations thereof.
